(19) United States
(12) Patent Application Publication
(10) Pub. No.: US 2024/0253274 A1
(43) Pub. Date: Aug. 1, 2024

(54) MATERIAL SUPPLY DEVICE AND PLASTICIZING DEVICE

(71) Applicant: SEIKO EPSON CORPORATION, Tokyo (JP)

(72) Inventors: Asami KAJIHARA, SHIOJIRI-SHI (JP); Hidenobu MARUYAMA, AZUMINO-SHI (JP)

(21) Appl. No.: 18/425,169

(22) Filed: Jan. 29, 2024

(30) Foreign Application Priority Data
Jan. 31, 2023 (JP) 2023-012633

(51) Int. Cl. B29C 31/06; B29C 64/329; B29K 55/02; B33Y 40/00

(52) U.S. Cl. CPC B29C 31/061; B29C 64/329; B29K 2055/02; B33Y 40/00

(57) ABSTRACT

In a material supply device for supplying a material to a plasticizing unit that plasticizes the material to generate a plasticized material, the material supply device includes: a housing having an inlet through which the material is fed into the plasticizing unit, and configured to accommodate the material; and a supply mechanism provided in the housing, positioned above the inlet, and configured to intermittently supply the material to the inlet. The housing has an inclined wall that defines an accommodation space for the material above the supply mechanism and is inclined such that a volume of the accommodation space is reduced downward, and the supply mechanism at least partially overlaps the inclined wall when viewed from a vertical direction.

The present application is based on, and claims priority from JP Application Serial Number 2023-012633, filed Jan. 31, 2023, the disclosure of which is hereby incorporated by reference herein in its entirety.

### BACKGROUND

### 1. Technical Field

The present disclosure relates to a material supply device and a plasticizing device.

### 2. Related Art

There is known an injection molding device which injects a material plasticized by a plasticizing device toward a cavity and molds a molded product by curing the material.

For example, JP A-2022-36539 describes a plasticizing device including a supply mechanism that includes a rotation member rotatable along an inner edge of a housing accommodating a material and supplies the material little by little.

JP A-2022-36539 is an example of the related art.

However, in the supply mechanism described in JP A-2022-36539, when the material enters between the rotation member and the housing, the rotation of the rotation member is hindered, and a supply failure of the material may occur.

### SUMMARY

A material supply device according to an aspect of the present disclosure is a material supply device for supplying a material to a plasticizing unit that plasticizes the material to generate a plasticized material, the material supply device including:
a housing having an inlet through which the material is fed into the plasticizing unit, and configured to accommodate the material; and
a supply mechanism provided in the housing, positioned above the inlet, and configured to intermittently supply the material to the inlet, in which
the housing has an inclined wall that defines an accommodation space for the material above the supply mechanism and is inclined such that a volume of the accommodation space is reduced downward, and
the supply mechanism at least partially overlaps the inclined wall when viewed from a vertical direction.

A plasticizing device according to an aspect of the present disclosure includes:
the material supply device according to the aspect; and
the plasticizing unit.

### BRIEF DESCRIPTION OF THE DRAWINGS

FIG. 1 is a side view schematically showing an injection molding device according to an embodiment.

FIG. 2 is a cross-sectional view schematically showing the injection molding device according to the embodiment.

FIG. 3 is a perspective view schematically showing a flat screw of the injection molding device according to the embodiment.

FIG. 4 is a view schematically showing a barrel of the injection molding device according to the embodiment.

FIG. 5 is a perspective view schematically showing a material supply device of the injection molding device according to the embodiment.

FIG. 6 is a side view schematically showing the material supply device of the injection molding device according to the embodiment.

FIG. 7 is a cross-sectional view schematically showing the material supply device of the injection molding device according to the embodiment.

FIG. 8 is a cross-sectional view schematically showing a three-dimensional shaping device according to the embodiment.

FIG. 9 is a graph showing a relationship between a drive time of a motor and a motor load factor.

### DESCRIPTION OF EMBODIMENTS

Hereinafter, a preferred embodiment of the present disclosure will be described in detail with reference to the drawings. The embodiment to be described below does not unduly limit contents of the present disclosure described in the claims. In addition, not all configurations to be described below are necessarily essential components of the present disclosure.

### 1. Injection Molding Device

### 1.1. Overall Configuration

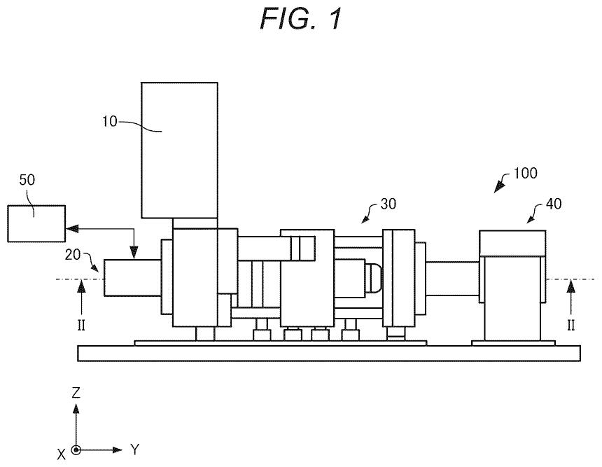

First, an injection molding device according to the embodiment will be described with reference to the drawings. FIG. 1 is a side view schematically showing an injection molding device 100 according to the embodiment. FIG. 1 shows an X-axis, a Y-axis, and a Z-axis as three axes orthogonal to one another. An X-axis direction and a Y-axis direction are, for example, horizontal directions. A Z-axis direction is, for example, a vertical direction.

As shown in FIG. 1, the injection molding device 100 includes, for example, a material supply device 10, an injection unit 20, a mold portion 30, a mold clamping unit 40, and a control unit 50.

The material supply device 10 supplies a material serving as a raw material to the injection unit 20. A shape of the material supplied from the material supply device 10 is, for example, a pellet shape or a powder shape. The shape of the material supplied from the material supply device 10 may be various shapes pulverized by a pulverizer. Details of the material supply device 10 will be described later.

The injection unit 20 plasticizes the material supplied from the material supply device 10 to obtain a plasticized material. The injection unit 20 injects the plasticized material toward the mold portion 30.

“Plasticize” is a concept including melting, and means changing from a solid state to a flowable state. Specifically, for a material in which glass transition occurs, the “plasticize” refers to setting a temperature of the material to be equal to or higher than a glass transition point. For a material in which the glass transition does not occur, the “plasticize” refers to setting the temperature of the material to a temperature equal to or higher than a melting point.

A cavity corresponding to a shape of a molded product is formed in the mold portion 30. The plasticized material injected from the injection unit 20 flows into the cavity. Then, the plasticized material is cooled and solidified to generate the molded product.

The mold clamping unit 40 opens and closes the mold portion 30. The mold clamping unit 40 opens the mold portion 30 after the plasticized material is cooled and solidified. Accordingly, the molded product is dispensed to the outside.

The control unit 50 is implemented by, for example, a computer including a processor, a main storage device, and an input and output interface that inputs and outputs a signal from and to the outside. The control unit 50 exerts various functions by, for example, executing, by the processor, a program read into the main storage device. Specifically, the control unit 50 controls the injection unit 20 and the mold clamping unit 40. The control unit 50 may be implemented by a combination of a plurality of circuits instead of the computer.

### 1.2. Specific Configuration

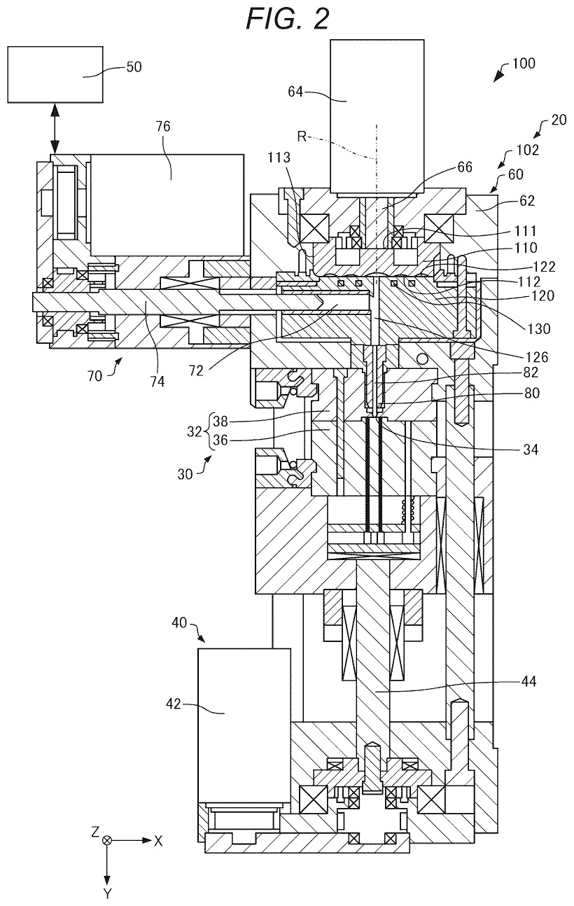

FIG. 2 is a cross-sectional view taken along a line II-II of FIG. 1 schematically showing the injection molding device 100. As shown in FIG. 2, the injection unit 20 includes, for example, a plasticizing unit 60, an injection mechanism 70, and a nozzle 80.

The plasticizing unit 60 is formed to plasticize the material supplied from the material supply device 10, generate a flowable plasticized material in a paste shape, and guide the plasticized material to the injection mechanism 70. The plasticizing unit 60 and the material supply device 10 form a plasticizing device 102. The plasticizing device 102 includes the plasticizing unit 60 and the material supply device 10. The plasticizing unit 60 includes, for example, a screw case 62, a drive motor 64, a flat screw 110, a barrel 120, and a heater 130.

The screw case 62 is a housing that accommodates the flat screw 110. The flat screw 110 is accommodated in a space surrounded by the screw case 62 and the barrel 120.

The drive motor 64 is coupled to the screw case 62. The drive motor 64 rotates the flat screw 110. The drive motor 64 is, for example, a servomotor. A shaft 66 of the drive motor 64 is coupled to the flat screw 110. The drive motor 64 is controlled by the control unit 50.

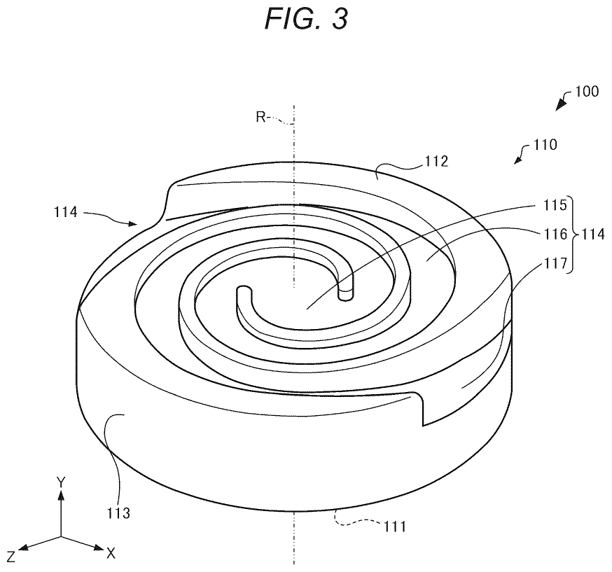

The flat screw 110 has a substantially cylindrical shape in which a size in a direction of a rotation axis R is smaller than a size in a direction orthogonal to the direction of the rotation axis R. In a shown example, the rotation axis R is parallel to the Y-axis. The flat screw 110 is rotated about the rotation axis R by a torque generated by the drive motor 64. The flat screw 110 has a motor side surface 111 on the drive motor 64 side, a groove formation surface 112 on a side opposite to the motor side surface 111, and a coupling surface 113 coupled to the groove formation surface 112. Here, FIG. 3 is a perspective view schematically showing the flat screw 110. For convenience, FIG. 3 shows a state in which an up-down positional relationship is reversed from a state shown in FIG. 2.

As shown in FIG. 3, first grooves 114 are formed in the groove formation surface 112 of the flat screw 110. The first groove 114 has a spiral shape. The first groove 114 includes, for example, a central portion 115, a coupling portion 116, and a material introduction portion 117. The central portion 115 faces a communication hole 126 formed in the barrel 120. The central portion 115 communicates with the communication hole 126. The coupling portion 116 couples the central portion 115 to the material introduction portion 117. In the shown example, the coupling portion 116 is formed in a spiral shape from the central portion 115 toward an outer periphery of the groove formation surface 112. The material introduction portion 117 is formed on the outer periphery of the groove formation surface 112. That is, the material introduction portion 117 is formed on the coupling surface 113 of the flat screw 110. The material supplied from the material supply device 10 is introduced from the material introduction portion 117 into the first groove 114, passes through the coupling portion 116 and the central portion 115, and is conveyed to the communication hole 126 formed in the barrel 120. In the shown example, two first grooves 114 are formed.

The number of the first grooves 114 is not particularly limited. Although not shown, three or more first grooves 114 may be formed, or only one first groove 114 may be formed. Although not shown, the plasticizing unit 60 may include an elongated in-line screw having a spiral groove on a side surface thereof, instead of the flat screw 110. The plasticizing unit 60 may plasticize the material by rotation of the in-line screw.

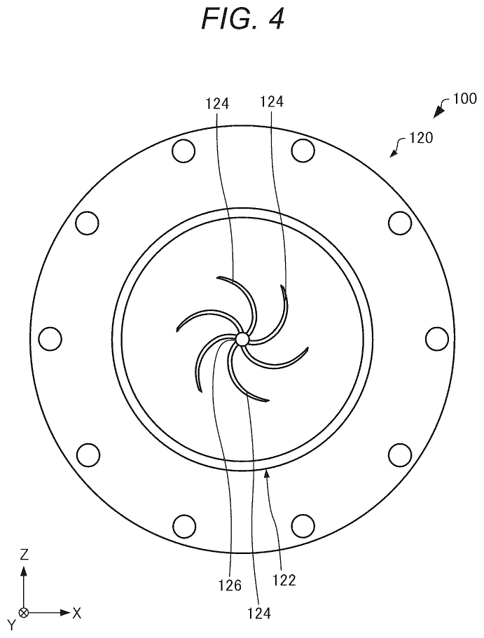

As shown in FIG. 2, the barrel 120 is provided to face the flat screw 110. The barrel 120 has a facing surface 122 facing the groove formation surface 112 of the flat screw 110. The facing surface 122 faces the groove formation surface 112 in the Y-axis direction. The communication hole 126 is formed at a center of the facing surface 122. Here, FIG. 4 is a view schematically showing the barrel 120.

As shown in FIG. 4, second grooves 124 and the communication hole 126 are formed in the facing surface 122 of the barrel 120. A plurality of second grooves 124 are formed. In the shown example, six second grooves 124 are formed, and the number of the second grooves 124 is not particularly limited. The plurality of second grooves 124 are formed around the communication hole 126 when viewed from the Y-axis direction. The second groove 124 has one end coupled to the communication hole 126, and extends spirally from the communication hole 126 toward an outer periphery of the facing surface 122. The second groove 124 has a function of guiding the plasticized material to the communication hole 126. The plasticized material flows into the communication hole 126. The communication hole 126 allows the plasticized material that has flowed in to flow out of the barrel 120.

A shape of the second groove 124 is not particularly limited, and may be, for example, a linear shape. The one end of the second groove 124 may not be coupled to the communication hole 126. Further, the second groove 124 may not be formed in the facing surface 122. However, in consideration of efficiently guiding the plasticized material to the communication hole 126, the second groove 124 is preferably formed in the facing surface 122.

As shown in FIG. 2, the heater 130 is provided in the barrel 120. The heater 130 heats the material supplied between the flat screw 110 and the barrel 120. The heater 130 heats the material supplied to the first grooves 114. The heater 130 is controlled by the control unit 50. The plasticizing unit 60 generates the plasticized material by heating the material while conveying the material toward the communication hole 126 by the flat screw 110, the barrel 120, and the heater 130, and causes the generated plasticized material to flow out from the communication hole 126 to the injection mechanism 70.

The injection mechanism 70 includes, for example, a cylinder 72, a plunger 74, and a plunger driving unit 76. The cylinder 72 is a substantially cylindrical member coupled to the communication hole 126. The plunger 74 moves inside the cylinder 72. The plunger 74 is driven by the plunger driving unit 76 implemented by a motor, a gear, and the like. The plunger driving unit 76 is controlled by the control unit 50. The cylinder 72 may be coupled to a flow path downstream of the communication hole 126.

The injection mechanism 70 executes a metering operation and an injection operation by sliding the plunger 74 in the cylinder 72. The metering operation refers to an operation of guiding the plasticized material positioned in the communication hole 126 into the cylinder 72 and metering the plasticized material in the cylinder 72 by moving the plunger 74 in the −X-axis direction away from the communication hole 126. The injection operation refers to an operation of injecting the plasticized material in the cylinder 72 into the mold portion 30 through the nozzle 80 by moving the plunger 74 in the +X-axis direction approaching the communication hole 126.

A nozzle hole 82 communicating with the communication hole 126 is formed in the nozzle 80. The nozzle 80 injects the plasticized material supplied from the plasticizing unit 60 toward a molding mold 32 of the mold portion 30. Specifically, the plasticized material metered in the cylinder 72 is sent from the injection mechanism 70 to the nozzle hole 82 through the communication hole 126 by executing the metering operation and the injection operation described above. The plasticized material is injected from the nozzle hole 82 into the mold portion 30.

The mold portion 30 includes the molding mold 32. The plasticized material sent to the nozzle hole 82 is injected from the nozzle hole 82 into the cavity 34 of the molding mold 32. Specifically, the molding mold 32 includes a movable mold 36 and a fixed mold 38 facing each other, and includes a cavity 34 between the movable mold 36 and the fixed mold 38. The cavity 34 is a space corresponding to the shape of the molded product. The movable mold 36 and the fixed mold 38 are made of metal. The movable mold 36 and the fixed mold 38 may be made of ceramic or a resin.

The mold clamping unit 40 includes, for example, a mold driving unit 42 and a ball screw unit 44. The mold driving unit 42 is implemented by, for example, a motor, a gear, and the like. The mold driving unit 42 is coupled to the movable mold 36 via the ball screw unit 44. The mold driving unit 42 is controlled by the control unit 50. The ball screw unit 44 transmits power generated by the driving of the mold driving unit 42 to the movable mold 36. The mold clamping unit 40 opens and closes the mold portion 30 by moving the movable mold 36 by the mold driving unit 42 and the ball screw unit 44.

### 1.3. Material Supply Device

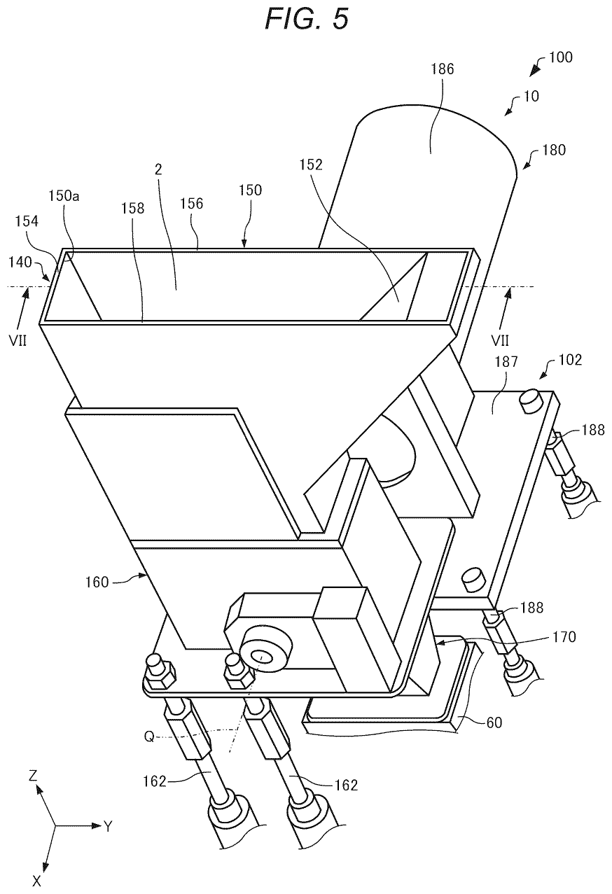

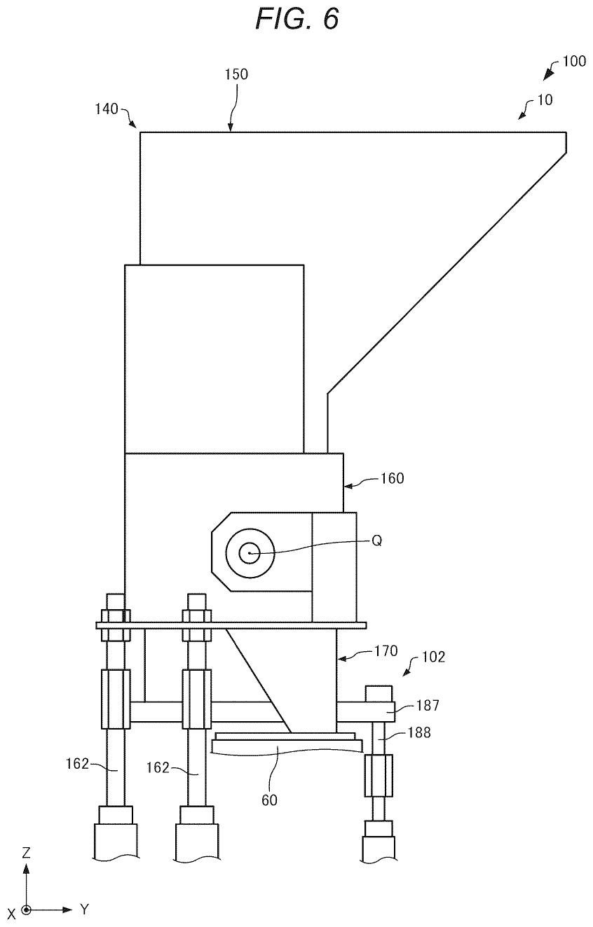

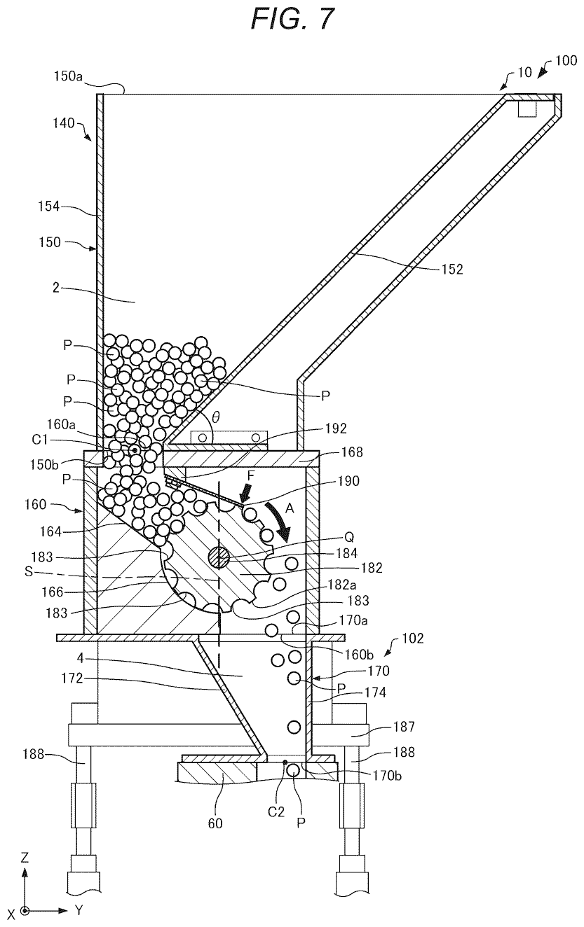

FIG. 5 is a perspective view schematically showing the material supply device 10. FIG. 6 is a side view schematically showing the material supply device 10. FIG. 7 is a cross-sectional view taken along a line VII-VII of FIG. 5 schematically showing the material supply device 10.

As shown in FIGS. 5 to 7, the material supply device 10 includes, for example, a housing 140, a rotation mechanism 180, and a sliding contact member 190. The material supply device 10 supplies a material P to the plasticizing unit 60. The plasticizing unit 60 plasticizes the material P to generate a plasticized material. For convenience, in FIGS. 5 to 7, the plasticizing unit 60 is shown in a simplified manner.

The housing 140 accommodates the material P. A material of the housing 140 is, for example, metal. The housing 140 includes, for example, a first structure 150, a second structure 160, and a third structure 170.

As shown in FIG. 7, the first structure 150 has a first opening 150a and a second opening 150b. The material P is fed into the material supply device 10 from the first opening 150a by a user, and is guided to the second opening 150b. When viewed from the Z-axis direction, the second opening 150b overlaps the first opening 150a.

As shown in FIG. 5, the first structure 150 includes, for example, an inclined wall 152, a first wall 154, a second wall 156, and a third wall 158.

The inclined wall 152, the first wall 154, the second wall 156, and the third wall 158 form an inner wall of the housing 140. In the shown example, the first wall 154 is provided in the −Y-axis direction of the inclined wall 152. The second wall 156 is coupled to the inclined wall 152 and the first wall 154. The third wall 158 is coupled to the inclined wall 152 and the first wall 154. The third wall 158 is provided to face the second wall 156.

The inclined wall 152, the first wall 154, the second wall 156, and the third wall 158 form, for example, a hopper. The walls 152, 154, 156, and 158 are positioned above a rotation member 182 of the rotation mechanism 180 and define a material accommodation space 2 that is an accommodation space for the material P. In the shown example, the “above” is the +Z-axis direction. The “below” is the −Z-axis direction. As shown in FIG. 7, the material accommodation space 2 has the first opening 150a and the second opening 150b, and extends from the first opening 150a to the second opening 150b. Shapes of the first opening 150a and the second opening 150b are, for example, rectangular.

The inclined wall 152 is inclined such that a volume of the material accommodation space 2 for the material P is reduced downward. The inclined wall 152 receives the material P from the first opening 150a and conveys the material P by causing the material P to slide toward the second opening 150b. In the shown example, a width of the material accommodation space 2 decreases toward the −Z-axis direction. As in the shown example, the width of the material accommodation space 2 may not decrease from the first opening 150a toward the second opening 150b, and a portion between the first opening 150a and the second opening 150b may not be inclined. The second opening 150b of the material accommodation space 2 is a narrowed portion in which the volume of the material accommodation space is reduced by the inclined wall 152. The second opening 150b is a narrowed portion in which the width of the material accommodation space 2 is the smallest. In the example shown in FIG. 7, the width of the material accommodation space 2 is a distance between the inclined wall 152 and the first wall 154. An opening area of the second opening 150b is the smallest in the material accommodation space 2.

An inclination angle θ of the inclined wall 152 with respect to the horizontal direction is, for example, 15° or more and 60° or less. Specifically, the inclination angle θ is an inclination angle of an inner surface of the inclined wall 152 with respect to the horizontal direction. Inner surfaces of the walls 154, 156, and 158 are, for example, perpendicular to the horizontal direction.

The second structure 160 is coupled to the first structure 150. The second structure 160 is provided below the first structure 150. The second structure 160 is provided between the first structure 150 and the third structure 170. In the example shown in FIG. 5, the second structure 160 is supported by first support members 162.

As shown in FIG. 7, the second structure 160 has a third opening 160a and a fourth opening 160b. The material P supplied from the second opening 150b of the first structure 150 is introduced into the second structure 160 from the third opening 160a, and is guided to the fourth opening 160b via the rotation member 182. In the shown example, the second opening 150b and the third opening 160a are positioned at the same position in the Z-axis direction. When viewed from the Z-axis direction, the fourth opening 160b does not overlap the third opening 160a.

The second structure 160 includes, for example, a receiving portion 164 that receives the material P from the third opening 160a, and a sliding contact object portion 166 with which the rotation member 182 slides.

The receiving portion 164 overlaps the third opening 160a when viewed from the Z-axis direction. The receiving portion 164 is in contact with the material P. The receiving portion 164 has a shape inclined with respect to the horizontal direction, such that the material P is guided to the rotation member 182.

The sliding contact object portion 166 is provided below the receiving portion 164. The sliding contact object portion 166 is coupled to the receiving portion 164. The sliding contact object portion 166 has a shape along an outer periphery 182a of the rotation member 182. The sliding contact object portion 166 is not in contact with, for example, the material P.

The third structure 170 is coupled to the second structure 160. The third structure 170 is provided below the second structure 160. The third structure 170 is provided between the second structure 160 and the plasticizing unit 60.

The third structure 170 has a fifth opening 170a and a sixth opening 170b. The material P supplied from the fourth opening 160b of the second structure 160 is introduced into the third structure 170 from the fifth opening 170a, and guided to the sixth opening 170b. The sixth opening 170b feeds the material P into the plasticizing unit 60. The sixth opening 170b is an inlet through which the material P is fed into the plasticizing unit 60. In the shown example, the fourth opening 160b and the fifth opening 170a are positioned at the same position in the Z-axis direction. When viewed from the Z-axis direction, the sixth opening 170b overlaps the fifth opening 170a.

The third structure 170 includes, for example, a fourth wall 172 and a fifth wall 174. The walls 172 and 174 form the inner wall of the housing 140. The walls 172 and 174 define a material flow path 4 which is a flow path of the material P. The material flow path 4 has the fifth opening 170a and the sixth opening 170b, and extends from the fifth opening 170a to the sixth opening 170b.

The fourth wall 172 is inclined with respect to the horizontal direction such that a width of the material flow path 4 decreases toward the −Z-axis direction. In the example shown in FIG. 7, the width of the material flow path 4 is a distance between the fourth wall 172 and the fifth wall 174. An opening area of the sixth opening 170b is smaller than the opening area of the fifth opening 170a. The fourth wall 172 may or may not be in contact with the material P.

For example, a microdimple (MD) treatment is performed on at least a part of the inner wall of the housing 140. The MD treatment may be performed on the entire inner wall of the housing 140. For example, the MD treatment may be performed on the walls 152, 154, 156, 158, 172, and 174, the receiving portion 164, and the sliding contact object portion 166. The opening area of the sixth opening 170b is smaller than opening areas of the openings 150a, 150b, 160a, 160b, and 170a. Accordingly, in order to prevent clogging of the material P in the sixth opening 170b, it is particularly preferable that an inner wall of the third structure 170 defining the sixth opening 170b is subjected to the MD treatment. A fluorine coating treatment may be performed instead of the MD treatment. In addition to the MD treatment, the fluorine coating treatment may be performed.

The rotation mechanism 180 includes, for example, the rotation member 182, a shaft member 184, and a motor 186.

The rotation member 182 is provided in the housing 140. In the shown example, the rotation member 182 is provided in the second structure 160. The rotation member 182 is positioned above the sixth opening 170b. The rotation member 182 at least partially overlaps the inclined wall 152 when viewed from the Z-axis direction. The rotation member 182 may entirely overlap the inclined wall 152 when viewed from the Z-axis direction. The inclined wall 152 functions as an eaves for receiving the material P for the rotation member 182.

The rotation member 182 is rotated about a rotation axis Q by the motor 186. The rotation axis Q intersects the Z-axis direction. The rotation axis Q is, for example, orthogonal to the Z-axis direction. In the shown example, the rotation axis Q is parallel to the X-axis. When viewed from the Z-axis direction, the rotation member 182 and the rotation axis Q are positioned between a center C1 of the second opening 150b and a center C2 of the sixth opening 170b.

The rotation member 182 rotates clockwise as indicated by an arrow A in FIG. 7 when viewed from a direction in which the center C1 of the second opening 150b is positioned on a left side and the center C2 of the sixth opening 170b is positioned on a right side in a virtual plane S. The rotation member 182 rotates clockwise when viewed from the direction in which the center C1 of the second opening 150b is positioned on the left side and the center C2 of the sixth opening 170b is positioned on the right side in a direction along the rotation axis Q. In the shown example, the rotation member 182 rotates clockwise. The virtual plane S is a plane parallel to the vertical direction including the rotation axis Q. In the shown example, the virtual plane S is parallel to a plane including the X-axis and the Z-axis.

The rotation member 182 has recessed portions 183 on the outer periphery 182a. A plurality of the recessed portions 183 are provided. In the shown example, twelve recessed portions 183 are provided. For example, the plurality of recessed portions 183 are provided at equal intervals on the outer periphery 182a of the rotation member 182. Due to the plurality of recessed portions 183, the rotation member 182 has a gear shape. The material P is supplied to the recessed portions 183. The rotation member 182 lifts the material P supplied to the recessed portions 183 upward from the rotation axis Q once, and supplies the material P to the sixth opening 170b through the openings 160b and 170a. The rotation member 182 is a supply mechanism that intermittently supplies the material P to the sixth opening 170b.

The shaft member 184 is coupled to the rotation member 182. When viewed from the X-axis direction, a center of the shaft member 184 and the rotation axis Q overlap each other. The shaft member 184 is surrounded by the rotation member 182. When the shaft member 184 rotates about the rotation axis Q, the rotation member 182 rotates. The shaft member 184 is, for example, a rod-shaped member extending in the X-axis direction.

As shown in FIG. 5, the motor 186 is provided outside the housing 140. In the shown example, the motor 186 is disposed on a plate member 187. The plate member 187 is supported by second support members 188. The motor 186 is coupled to the shaft member 184. The motor 186 rotates the rotation member 182 through the shaft member 184. The motor 186 is a servomotor. The motor 186 is controlled by the control unit 50.

As shown in FIG. 7, the sliding contact member 190 is provided in the housing 140. The sliding contact member 190 is provided, for example, in the second structure 160. In the shown example, the sliding contact member 190 is fixed to a fixed member 192. The fixed member 192 is provided on a lower surface of an upper plate member 168 of the second structure 160. The sliding contact member 190 may be screwed to the fixed member 192. In the shown example, the sliding contact member 190 extends obliquely downward from the fixed member 192.

The sliding contact member 190 is in sliding contact with the outer periphery 182a of the rotation member 182. The sliding contact member 190 biases the outer periphery 182a toward the rotation axis Q. The sliding contact member 190 is in contact with the material P supplied to the recessed portions 183. The sliding contact member 190 presses the material P supplied to the recessed portions 183.

The sliding contact member 190 is, for example, a plate spring. A material of the sliding contact member 190 is, for example, stainless steel. A thickness of the sliding contact member 190 is, for example, 0.1 mm or more and less than 0.5 mm, and preferably 0.15 mm or more and 0.3 mm or less. A length of the sliding contact member 190 from a position where the sliding contact member 190 is in contact with the fixed member 192 to a position where the sliding contact member 190 is in contact with the outer periphery 182a is, for example, 15 mm or more and 40 mm or less, preferably 20 mm or more and 35 mm or less. A width of the sliding contact member 190 is, for example, 35 mm or more and 60 mm or less, and preferably 40 mm or more and 55 mm or less. In the shown example, the width of the sliding contact member 190 is a size of the sliding contact member 190 in the X-axis direction.

A force F applied to the outer periphery 182a of the rotation member 182 by the sliding contact member 190 is, for example, 0.1 N or more and less than 19 N, preferably 5 N or more and 18 N or less, more preferably 10 N or more and 14 N or less, and still more preferably 12 N. The force F is a force biases the outer periphery 182a toward the rotation axis Q.

### 1.4. Function and Effect

The material supply device 10 includes the housing 140 that has the sixth opening 170b serving as the inlet through which the material P is fed into the plasticizing unit 60 and accommodates the material P, and the rotation member 182 that is provided in the housing 140, is positioned above the sixth opening 170b, and serves as a supply mechanism for intermittently supplying the material P to the sixth opening 170b. The housing 140 has the inclined wall 152 that defines the material accommodation space 2 that is the accommodation space for the material P above the rotation member 182 and is inclined such that the volume of the material accommodation space 2 is reduced downward. When viewed from the vertical direction, the rotation member 182 at least partially overlaps the inclined wall 152.

Therefore, in the material supply device 10, by the inclined wall 152, it is possible to prevent a load of the material P from being directly applied to the rotation member 182, and it is possible to prevent the load of the material P from being concentrated on the rotation member 182. Accordingly, it is possible to prevent an operation failure of the rotation member 182 due to clogging of the material P and the like. As a result, it is possible to prevent a supply failure of the material P.

The material supply device 10 includes the motor 186, and the rotation member 182 is rotated about the rotation axis Q intersecting the vertical direction by the motor 186 and has the recessed portions 183 on the outer periphery 182a. Therefore, in the material supply device 10, the material P is supplied to the recessed portions 183, and the material P supplied to the recessed portions 183 can be intermittently supplied to the sixth opening 170b little by little.

In the material supply device 10, the housing 140 has the second opening 150b as a narrowed portion in which the volume of the material accommodation space 2 is reduced by the inclined wall 152. The rotation axis Q is positioned between the center C1 of the second opening 150b and the center C2 of the sixth opening 170b when viewed from the vertical direction. Therefore, in the material supply device 10, the material P from the second opening 150b can be supplied to the sixth opening 170b by the rotation of the rotation member 182.

In the material supply device 10, when viewed from the direction in which the center C1 of the second opening 150b is positioned on the left side and the center C2 of the sixth opening 170b is positioned on the right side in the direction along the rotation axis Q, the rotation member 182 rotates clockwise. Therefore, in the material supply device 10, the rotation member 182 can lift the material P supplied to the recessed portions 183 upward from the rotation axis Q once. Accordingly, the material P supplied to the recessed portions 183 can be supplied to the sixth opening 170b by an own weight of the material P.

The material supply device 10 includes the sliding contact member 190 that is in sliding contact with the outer periphery 182a of the rotation member 182 and biases the outer periphery 182a of the rotation member 182 toward the rotation axis Q. Therefore, in the material supply device 10, it is possible to reduce the possibility that the material P supplied to the recessed portions 183 is scattered.

In the material supply device 10, the force F applied to the outer periphery 182a of the rotation member 182 by the sliding contact member 190 is 0.1 N or more and less than 19 N. In the material supply device 10, since the force F is 0.1 N or more, it is possible to reduce the possibility that the material P supplied to the recessed portions 183 is scattered. Further, since the force F is less than 19 N, a load on the motor 186 can be reduced as shown in an experimental example to be described later. Further, since the force F is less than 19 N, noise generated by contact between the sliding contact member 190 and the outer periphery 182a can be prevented.

In the material supply device 10, the inclination angle θ of the inclined wall 152 with respect to the horizontal direction is 15° or more and 60° or less. In the material supply device 10, since the inclination angle θ is 15° or more, the inclined wall 152 can convey the material P by causing the material P to slide. Further, since the inclination angle θ is 60° or less, the material P can be temporarily stored in the housing 140. Specifically, the material P can be temporarily stored in the first structure 150.

In the material supply device 10, at least one of the MD treatment and the fluorine coating treatment is performed on at least a part of the inner wall of the housing 140. Therefore, in the material supply device 10, it is possible to improve the slip of the material P on at least a part of the inner wall of the housing 140. Accordingly, it is possible to reduce the possibility that the material P is clogged.

Although an example in which the rotation member 182 is used as the supply mechanism that intermittently supplies the material P has been described above, the supply mechanism is not limited to the rotation member 182. The supply mechanism may be, for example, a valve that intermittently supplies the material P.

1.5. Material Supplied from Material Supply Device

The material P supplied from the material supply device 10 is, for example, various materials such as thermoplastic materials, metal materials, and ceramic materials as main materials. Here, the “main material” means a material serving as a core material forming the shape of the molded product molded by the injection molding device 100, and means a material having a content of 50% by mass or more in the molded product. The materials described above include those materials obtained by melting these main materials alone, and those materials obtained by melting the main materials and a part of contained components into a paste shape.

Examples of the thermoplastic material include a thermoplastic resin. Examples of the thermoplastic resin include acrylonitrile butadiene styrene (ABS) resin, polyethylene (PE), polypropylene (PP), polyethylene terephthalate (PET), and polyvinyl chloride (PVC).

The thermoplastic resin may be a general-purpose engineering plastic. Examples of the general-purpose engineering plastic include polyacetal (POM), polyamide (PA), polylactic acid (PLA), polyphenylene sulfide (PPS), polycarbonate (PC), and modified polyphenylene ether (m-PPE).

The thermoplastic resin may be super engineering plastic. Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyether ether ketone (PEEK).

The thermoplastic material may be an elastomer. Examples of the elastomer include polystyrene (TPS), olefin/alkene (TPO), polyvinyl chloride (TPVC), polyurethane (TPU), polyester (TPEE), and polyamide (TPAE). The elastomer has a small Young's modulus and a large breaking strain, and easily enters a gap. Even when such an elastomer is the material P, the material supply device 10 can prevent the load of the material P from concentrating on the rotation member 182 by the inclined wall 152, and thus can prevent the supply failure.

In addition to a pigment, a metal, and a ceramic, additives such as a wax, a flame retardant, an antioxidant, and a heat stabilizer may be mixed into the thermoplastic material. In the plasticizing unit 60, the thermoplastic material is plasticized and converted into a molten state by rotation of the flat screw 110 and heating of the heater 130. The plasticized material generated in this manner is deposited from the nozzle 80, and then is cured due to a decrease in temperature. It is desirable that the thermoplastic material is dispensed from the nozzle 80 in a completely molten state by being heated to a glass transition point or higher.

In the plasticizing unit 60, for example, a metal material may be used as a main material instead of the above-described thermoplastic material. In this case, it is desirable that a powder material obtained by powdering the metal material is mixed with a component that melts when the plasticized material is generated, and the mixture is fed into the plasticizing unit 60.

Examples of the metal material include a single metal such as magnesium (Mg), iron (Fe), cobalt (Co), chromium (Cr), aluminum (Al), titanium (Ti), copper (Cu), and nickel (Ni), or an alloy containing one or more of these metals, maraging steel, stainless steel, cobalt chromium molybdenum, a titanium alloy, a nickel alloy, an aluminum alloy, a cobalt alloy, and a cobalt chromium alloy.

In the plasticizing unit 60, a ceramic material may be used as the main material instead of the above-described metal material. Examples of the ceramic material include an oxide ceramic such as silicon dioxide, titanium dioxide, aluminum oxide, and zirconium oxide, and a non-oxide ceramic such as aluminum nitride.

The powder material of the metal material or the ceramic material supplied from the material supply device 10 may be a mixed material obtained by mixing a plurality of types of powder of the single metal, powder of the alloy, or powder of the ceramic material. The powder material made of the metal material or the ceramic material may be coated with, for example, the thermoplastic resin described above or another thermoplastic resin. In this case, in the plasticizing unit 60, the thermoplastic resin coated with the powder material may melt to develop fluidity.

For example, a solvent can be added to the powder material of the metal material or the ceramic material to be supplied from the material supply device 10. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetate (for example, tetrabutylammonium acetate); and ionic liquids such as butyl carbitol acetate.

In addition, for example, a binder may be added to the powder material of the metal material or the ceramic material supplied from the material supply device 10. Examples of the binder include an acrylic resin, an epoxy resin, a silicone resin, a cellulose-based resin, other synthetic resins, PLA, PA, PPS, PEEK, and other thermoplastic resins.

### 2. Three-Dimensional Shaping Device

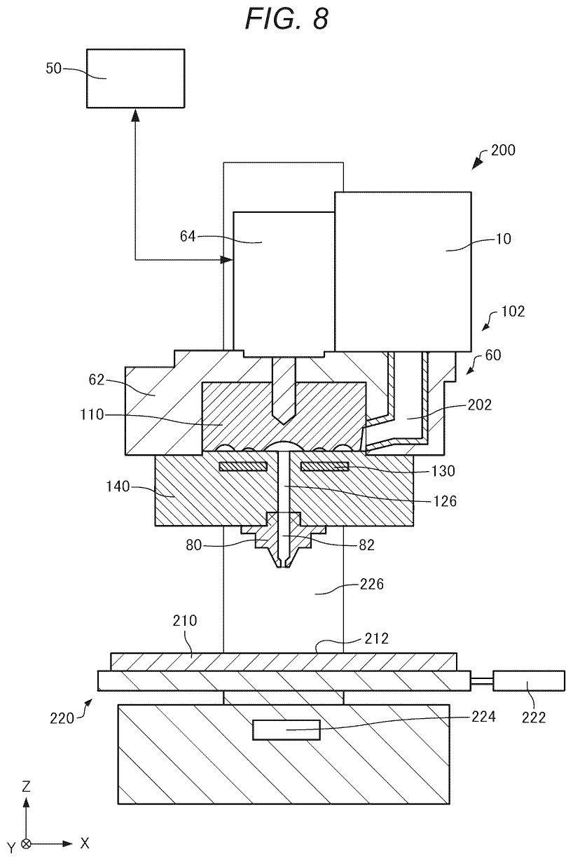

Next, a three-dimensional shaping device according to the embodiment will be described with reference to the drawings. FIG. 8 is a cross-sectional view schematically showing a three-dimensional shaping device 200 according to the embodiment.

For example, as shown in FIG. 8, the three-dimensional shaping device 200 includes the material supply device 10, the control unit 50, the plasticizing unit 60, the nozzle 80, a stage 210, and a position changing unit 220. The three-dimensional shaping device 200 is a three-dimensional shaping device of fused deposition modeling (FDM) (registered trademark) type. For convenience, the material supply device 10 is shown in a simplified manner in FIG. 8.

The material supply device 10 supplies the material to the plasticizing unit 60 through a supply path 202. The plasticizing unit 60 plasticizes the material to generate the plasticized material.

The nozzle 80 dispenses the plasticized material supplied from the plasticizing unit 60 toward the stage 210. Specifically, the three-dimensional shaping device 200 changes relative positions of the nozzle 80 and the stage 210 by driving the position changing unit 220 while dispensing the plasticized material from the nozzle 80 to the stage 210. Accordingly, the three-dimensional shaping device 200 shapes a three-dimensional shaping object having a desired shape on the stage 210.

The stage 210 is provided below the nozzle 80. In the shown example, the stage 210 has a rectangular parallelepiped shape. The stage 210 supports the plasticized material dispensed from the nozzle 80. The stage 210 has a deposition surface 212 on which the plasticized material is deposited.

A material of the stage 210 is, for example, a metal such as aluminum. The stage 210 may be formed of a metal plate and an adhesive sheet provided on the metal plate. In this case, the deposition surface 212 is formed of the adhesive sheet. The adhesive sheet can improve an adhesion between the stage 210 and the plasticized material dispensed from the nozzle 80.

Although not shown, the stage 210 may be formed of a metal plate in which a groove is formed, and an underlayer provided to fill the groove. In this case, the deposition surface 212 is formed of the underlayer. A material of the underlayer is, for example, the same as the plasticized material. The underlayer can improve the adhesion between the stage 210 and the plasticized material dispensed from the nozzle 80.

The position changing unit 220 supports the stage 210. The position changing unit 220 changes the relative positions of the nozzle 80 and the stage 210. In the shown example, the position changing unit 220 changes the relative positions of the nozzle 80 and the stage 210 in the X-axis direction and the Y-axis direction by moving the stage 210 in the X-axis direction and the Y-axis direction. Further, the position changing unit 220 changes the relative positions of the nozzle 80 and the stage 210 in the Z-axis direction by moving the nozzle 80 in the Z-axis direction.

The position changing unit 220 includes, for example, a first electric actuator 222, a second electric actuator 224, and a third electric actuator 226. The first electric actuator 222 moves the stage 210 in the X-axis direction. The second electric actuator 224 moves the stage 210 in the Y-axis direction. The third electric actuator 226 moves the nozzle 80 in the Z-axis direction. The third electric actuator 226 supports, for example, the screw case 62 of the plasticizing unit 60.

A configuration of the position changing unit 220 is not particularly limited as long as the relative positions of the nozzle 80 and the stage 210 can be changed. For example, the position changing unit 220 may move the stage 210 in the Z-axis direction and move the nozzle 80 in the X-axis direction and the Y-axis direction, or may move the stage 210 or the nozzle 80 in the X-axis direction, the Y-axis direction, and the Z-axis direction.

### 3. Experimental Example

An experiment related to a load of a motor that rotates a rotation member was performed using a plate spring as a sliding contact member that slides on the rotation member.

A plate spring made of stainless steel was used as the plate spring. A length of the plate spring from a position where the plate spring is in contact with a fixed member to a position where the plate spring is in contact with an outer periphery of the rotation member was 28 mm. A width of the plate spring was 48 mm. Two plate springs having thicknesses of 0.2 mm and 0.5 mm were prepared.

As a material, an ABS resin “500-322” manufactured by Toray Industries Co., Ltd. was used. A convey amount of the ABS resin was 300 cc. A rotation speed of the motor for rotating the rotation member was 1.2 rpm. Then, when the thicknesses of the plate springs were 0.2 mm and 0.5 mm, a motor load factor applied to the motor was calculated. The motor load factor is a ratio of a torque value of the motor when a torque value causing an abnormality of the motor is 100%.

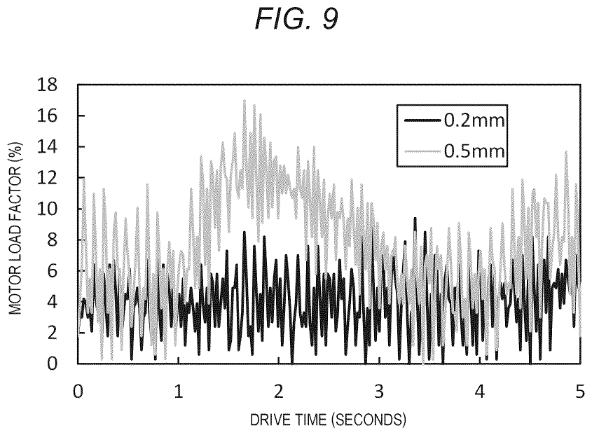

FIG. 9 is a graph showing a relationship between a drive time of the motor and the motor load factor. As shown in FIG. 9, the motor load factor was smaller and stable when the thickness of the plate spring was 0.2 mm than when the thickness of the plate spring was 0.5 mm. When the thickness of the plate spring was 0.2 mm, a maximum value of the motor load factor was 9.4%. When the thickness of the plate spring was 0.5 mm, the maximum value of the motor load factor was 17.0%.

The force F applied to the outer periphery of the rotation member by the plate spring was calculated based on the following equation (1). When the thickness of the plate spring was 0.2 mm, F=12 N. When the thickness of the plate spring was 0.5 mm, F=19 N. Accordingly, it was found that by setting the force F to less than 19 N, the motor load factor can be reduced and the driving of the motor can be stabilized.

$$δ = \frac{F {L}^{3}}{3 EI} \qquad ( 1 )$$

In the above equation (1), δ is a deflection amount of the plate spring at a position where the plate spring is in contact with the outer periphery of the rotation member. L is a length of the plate spring from the position where the plate spring is in contact with the fixed member to the position where the plate spring is in contact with the outer periphery of the rotation member. E is a longitudinal elastic modulus of the plate spring. I is a cross-sectional secondary moment of the plate spring.

The above-described embodiment and modifications are examples, and the present disclosure is not limited thereto. For example, the embodiment and the modifications may be also combined as appropriate.

The present disclosure includes substantially the same configuration, for example, a configuration having the same function, method, and result, or a configuration having the same object and effect, as the configuration described in the embodiment. The present disclosure includes a configuration in which a non-essential portion of the configuration described in the embodiment is replaced. The present disclosure includes a configuration capable of achieving the same function and effect or a configuration capable of achieving the same object as the configuration described in the embodiment. The present disclosure includes a configuration obtained by adding a known technique to the configuration described in the embodiment.

The following contents are derived from the above-described embodiment and modification.

A material supply device according to an aspect is a material supply device for supplying a material to a plasticizing unit that plasticizes the material to generate a plasticized material, the material supply device including:
a housing having an inlet through which the material is fed into the plasticizing unit, and configured to accommodate the material; and
a supply mechanism provided in the housing, positioned above the inlet, and configured to intermittently supply the material to the inlet, in which
the housing has an inclined wall that defines an accommodation space for the material above the supply mechanism and is inclined such that a volume of the accommodation space is reduced downward, and
the supply mechanism at least partially overlaps the inclined wall when viewed from a vertical direction.

According to the material supply device, it is possible to prevent an operation failure of the supply mechanism due to clogging of the material and the like. As a result, it is possible to prevent a supply failure of the material.

The material supply device according to an aspect may further include:
a motor, in which
the supply mechanism may be a rotation member that is rotated about a rotation axis intersecting the vertical direction by the motor, and
the rotation member may have a recessed portion on an outer periphery thereof.

According to the material supply device, the material can be supplied to the recessed portion, and the material supplied to the recessed portion can be intermittently supplied to the inlet little by little.

In the material supply device according to an aspect,
the housing may have a narrowed portion in which the volume of the accommodation space is reduced by the inclined wall, and
the rotation axis may be positioned between a center of the narrowed portion and a center of the inlet when viewed from the vertical direction.

According to the material supply device, the material from the narrowed portion can be supplied to the inlet by the rotation of the rotation member.

In the material supply device according to an aspect,
the rotation member may rotate clockwise when viewed from a direction in which the center of the narrowed portion is positioned on a left side and the center of the inlet is positioned on a right side in a direction along the rotation axis.

According to the material supply device, the material supplied to the recessed portion can be supplied to the inlet by an own weight of the material.

The material supply device according to an aspect may further include:
a sliding contact member configured to be in sliding contact with the outer periphery of the rotation member and bias the outer periphery of the rotation member toward the rotation axis.

According to the material supply device, it is possible to reduce the possibility that the material positioned in the recessed portion is scattered.

In the material supply device according to an aspect,
a force applied to the outer periphery of the rotation member by the sliding contact member may be 0.1 N or more and less than 19 N.

According to the material supply device, it is possible to reduce the possibility that the material positioned in the recessed portion is scattered, and further, it is possible to reduce a load of the motor.

In the material supply device according to an aspect,
an inclination angle of the inclined wall with respect to a horizontal direction may be 15° or more and 60° or less.

According to the material supply device, the inclined wall can convey the material by causing the material to slide, and can further temporarily store the material in the housing.

In the material supply device according to an aspect,
at least one treatment of a microdimple treatment and a fluorine coating treatment may be performed on at least a part of an inner wall of the housing.

According to the material supply device, it is possible to improve the slip of the material on at least a part of the inner wall of the housing.

A plasticizing device according to an aspect includes:
the material supply device according to the aspect; and
the plasticizing unit.

What is claimed is:

1. A material supply device for supplying a material to a plasticizing unit that plasticizes the material to generate a plasticized material, the material supply device comprising:
a housing having an inlet through which the material is fed into the plasticizing unit, and configured to accommodate the material; and
a supply mechanism provided in the housing, positioned above the inlet, and configured to intermittently supply the material to the inlet, wherein
the housing has an inclined wall that defines an accommodation space for the material above the supply mechanism and is inclined such that a volume of the accommodation space is reduced downward, and
the supply mechanism at least partially overlaps the inclined wall when viewed from a vertical direction.

2. The material supply device according to claim 1, further comprising:
a motor, wherein
the supply mechanism is a rotation member that is rotated about a rotation axis intersecting the vertical direction by the motor, and
the rotation member has a recessed portion on an outer periphery thereof.

3. The material supply device according to claim 2, wherein
the housing has a narrowed portion in which the volume of the accommodation space is reduced by the inclined wall, and
the rotation axis is positioned between a center of the narrowed portion and a center of the inlet when viewed from the vertical direction.

4. The material supply device according to claim 3, wherein
the rotation member rotates clockwise when viewed from a direction in which the center of the narrowed portion is positioned on a left side and the center of the inlet is positioned on a right side in a direction along the rotation axis.

5. The material supply device according to claim 2, further comprising:
a sliding contact member configured to be in sliding contact with the outer periphery of the rotation member and bias the outer periphery of the rotation member toward the rotation axis.

6. The material supply device according to claim 5, wherein
a force applied to the outer periphery of the rotation member by the sliding contact member is 0.1 N or more and less than 19 N.

7. The material supply device according to claim 1, wherein
an inclination angle of the inclined wall with respect to a horizontal direction is 15° or more and 60° or less.

8. The material supply device according to claim 1, wherein
at least one treatment of a microdimple treatment and a fluorine coating treatment is performed on at least a part of an inner wall of the housing.

9. A plasticizing device comprising:
the material supply device according to claim 1; and
the plasticizing unit.
